(19) United States
(12) Patent Application Publication
(10) Pub. No.: US 2008/0134676 A1
(43) Pub. Date: Jun. 12, 2008

(54) Power structure for a power-saving engine

(76) Inventor: Che-Ning Chang, Hsin-Chuang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/594,802

(22) Filed: Nov. 9, 2006

(51) Int. Cl. F02G 1/043

(52) U.S. Cl. 60/517

(57) ABSTRACT

A power structure for a power-saving engine prevents the piston from being excessively expanded and shrunk, and rapidly stores thermal energy to preheat fluid and reduce power consumption. The power structure for a power-saving engine includes a piston base having four piston areas, four cylinders, four power pistons, and a link mechanism. The piston base has a first fluid channel, and a second fluid channel. The cylinder has a cylinder cover, a cylinder jacket, and a heater. The power piston has a piston body and an airflow channel. The piston body has a piston head and an exhauster. The power piston moves between the cylinder and the moving area. The link mechanism has piston links that correspond and link to the power pistons. The piston links operate at different phases. The piston links link to the power pistons and move the power pistons to generate mechanical energy.

### BACKGROUND OF THE INVENTION

1. Field of the Invention

The present invention relates to a power structure for a power-saving engine. In particular, this invention relates to a power structure that includes a piston having an airflow channel, and an exhauster for storing heat. The airflow channel prevents the piston from expanding excessively so that the cylinder is reduced in size, and the exhauster stores heat to rapidly heat fluid so as to reduce power consumption.

2. Description of the Related Art

Stirling engines utilize the principle of expanding when hot and shrinking when cold to push the piston so as to generate power. In the engine, there is a cooling room and a heating room that are connected together. There is a power piston in the cooling room. In the heating room, there is a moving block that links to the power piston. By cooling and heating the cooling room, air flows in circles to push the power piston and move the moving block so as to generate power. Thereby, a generator or a compressor is driven.

Reference is made to FIGS. 1A˜1D, which show the operating principle of a Stirling engine 1a. A power piston 2a and an air-driving piston 3a move forwards and backwards in circles in the same direction in a cylinder 4a. A fluid received in the cylinder 4a is sealed and limited in the cylinder 4a so that the fluid cannot exhaust to the outside of the cylinder 4a through the power piston 2a and the air-driving piston 3a. The displacement of the air-driving piston 3a is used for controlling the fluid contacting the hot interface 5a and the cool interface 6a. The hot interface 5a provides thermal energy to the fluid. The cool interface 6a absorbs thermal energy from the fluid. The volume for the fluid controlled by the power piston 3a is called a compressed space 7a.

When the engine 1a moves in circles to a first phase status (as shown in FIG. 1A), the power piston 2a compresses the fluid in the compressed space 7a. The compressing process occurs in a constant temperature due to the thermal energy exhausting to the environment from the fluid. When the engine 1a is compressed and located at a second phase status (as shown in FIG. 1B), the air-driving piston 3a moves forward to the cool interface 6a. At this time, the fluid flows to the hot interface 5a from the cool interface 6a. This is called a transferring phase. When the transferring phase is ending, the fluid is heated in a constant volume and is in a high pressure status. When the engine 1a moves in circles to a third phase status—called an expanding phase (as shown in FIG. 1C), the volume of the compressed space 7a increases when the thermal energy is pumped into the compressed space 7a from outside of the engine 1a so that the thermal energy is transferred into power. The thermal energy is provided to the fluid from a heater. When the expending phase is ending, the compressed space 7a is fully filled with cool fluid. When the engine 1a moves in circles to a fourth phase status (as shown in FIG. 1D), the fluid moves to the cool interface 6a from the hot interface 5a via the air-driving piston 3a. When the fourth phase is ending, the fluid fully fills between the compressed space 7a and the cool interface 6a so that the recycling process is repeated.

However, Stirling engines still cannot be extensively applied to daily equipment due to their operating efficiency, usage life, and manufacturing costs, etc.

### SUMMARY OF THE INVENTION

One particular aspect of the present invention is to provide a power structure for a power-saving engine. The present invention installs an airflow channel in the power piston, and an exhauster in the power piston. The airflow channel adjusts the pressure in the piston to prevent the piston from expanding excessively so that the cylinder is reduced in size. The exhauster stores heat to rapidly heat the fluid to reduce power consumption.

Another particular aspect of the present invention is to install an airflow channel in the power piston so as to reduce the weight of the power piston. Thereby, the difference in pressure between the air operating area and the mechanical driving area is balanced.

A further particular aspect of the present invention is to install an airflow channel in the power piston to achieve a pressurizing effect and a decompressing effect. By adjusting the pressure in the piston, the operating efficiency of the piston and the cylinder is improved and increased.

The power structure for a power-saving engine includes a piston base having four piston areas, four cylinders corresponding to the piston areas, four power pistons corresponding to the cylinders, and a link mechanism inked to the power piston. The piston base has a first fluid channel, and a second fluid channel. The cylinder has a cylinder cover, a cylinder jacket located in the cylinder cover, and a heater located at the bottom of the cylinder cover. The power piston has a piston body, an airflow channel formed in and passing through the piston body. The piston body has a piston head, and an exhauster located at the piston head. The power piston moves between the cylinder and the moving area. The link mechanism has piston links that correspond and link to the power pistons. Each of the piston links operates at a different phase. The piston links link to the power pistons and moves the power pistons to generate mechanical energy.

Therefore, by moving forwards and backwards in circles the power pistons and the exhausters on a same shaft line in the cylinders via the piston link to generate mechanical energy, and via the first fluid channel and the second fluid channel, the pistons maintain a recycling action.

Furthermore, the piston will not expand excessively to prevent the cylinder from being shrunk due to the airflow channel. Moreover, an airflow channel installed in the power piston reduces the weight of the power piston and balances the pressure between an air operating area and a mechanical driving area. By adjusting the pressure in the piston via the airflow channel, the operating efficiency of the piston and the cylinder are improved.

For further understanding of the invention, reference is made to the following detailed description illustrating the embodiments and examples of the invention. The description is only for illustrating the invention and is not intended to be considered limiting of the scope of the claim.

### BRIEF DESCRIPTION OF THE DRAWINGS

The drawings included herein provide a further understanding of the invention. A brief introduction of the drawings is as follows:

FIGS. 1A˜1D are schematic diagrams of the operating principle of a Stirling engine of the prior art; and

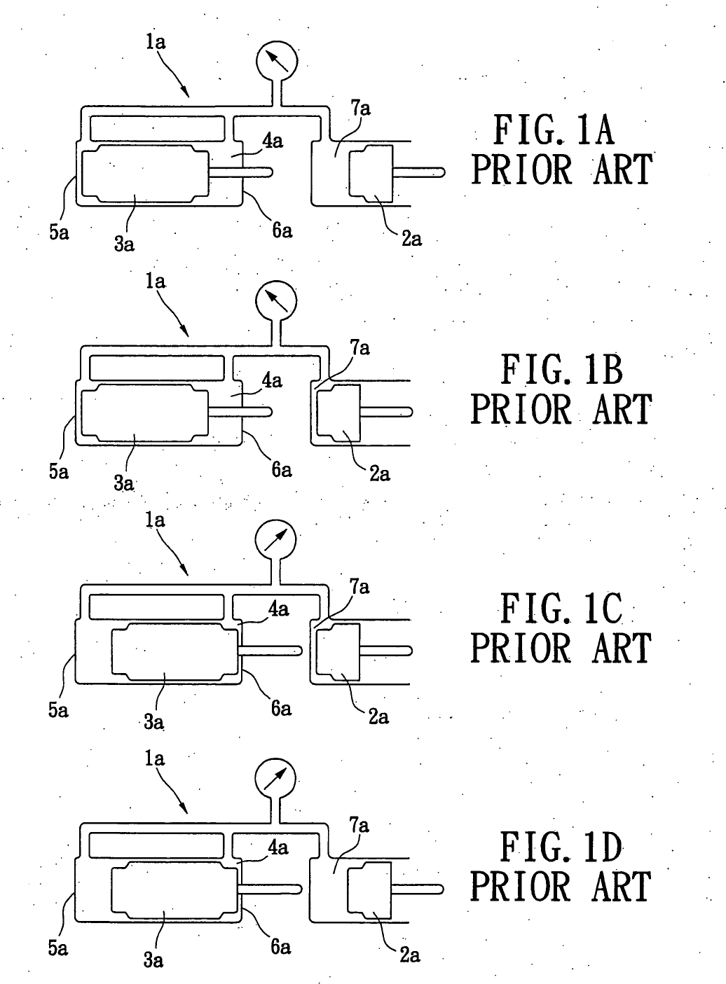

FIG. 2 is a schematic diagram of the power structure for a power-saving engine of the present invention.

### DETAILED DESCRIPTION OF THE PREFERRED EMBODIMENTS

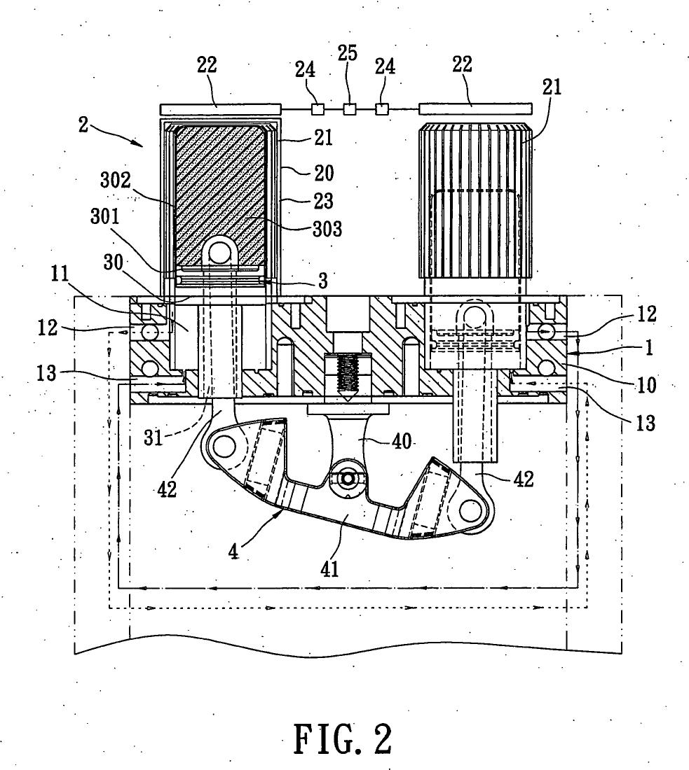

Reference is made to FIG. 2, which shows a schematic diagram of the power structure for a power-saving engine of the present invention. The power structure for the power-saving engine includes a piston base 1, four cylinders 2, four power pistons 3, and a link mechanism 4. The piston base 1 has a base body 10, four piston areas 11 formed at the base body 10, a first fluid channel 12 and a second fluid channel 13 respectively formed at the base body 10. The four cylinders 2 are respectively located to the corresponding piston areas 11. The cylinder 2 has a cylinder cover 20, a cylinder jacket 21 installed in the cylinder cover 20, and a heater 22 installed at the bottom of the cylinder cover 20. The heater can be a stove or a row of flames. The power pistons 3 respectively correspond to the cylinders 2, and move between the cylinders 2 and the piston areas 11. The power piston 3 has a piston body 30, and an airflow channel 31 formed in and passing through the piston body 30. The piston body 30 has a piston head 301, and an exhauster 302 located at the piston head 301. The link mechanism 4 has a fastening column 40 fastened at the piston base 1, a link base 41 rotatably linked to the fastening column 40, and four piston links 42 respectively linking to the link base 41. The piston links 42 respectively link to the power pistons 3. The four power pistons 3 are moved by the four piston links so that the power pistons 3 and the exhausters 302 move forwards and backwards in circles on a same shaft line in the cylinders to generate mechanical energy. Via the first fluid channel and the second fluid channel, the pistons maintain a recycling action.

The heater 22 provides thermal energy to heat the cylinder cover 20. The cylinder jacket 21 located in the cylinder cover 20 absorbs the thermal energy provided by the heater 22 and conducts the thermal energy to the exhauster 302 located in the cylinder 2. The thermal storing device 303 received in the exhauster 302 stores the thermal energy. The expanded air expanded by the thermal energy pushes and moves the exhauster 302 so as to push the piston head 301 to move forwards to the second fluid channel 13. A fluid in the second fluid channel 13 provides a cooling energy so that the piston head 301 is cooled and draws back to the heater 22 when the piston head 301 moves and contacts the second fluid channel 13. The fluid located in the second fluid channel 13 enters into a cylinder channel 23 via the piston area 11 and the fluid in the cylinder channel 23 is heated by the heater 22. When the exhauster 302 located in the cylinder 2 is pushed and moved by the expanded air, the thermal storing device 303 received in the exhauster 302 stores the thermal energy. The expanded air expanded by the thermal energy pushes and moves the exhauster 302 so as to push the piston head 301 to move forwards to the second fluid channel 13. Therefore, the fluid flows into the first fluid channel 12 from the cylinder channel 23 so as to flow into the second fluid channel of another piston area 11. Via the movements of the piston links 42, the piston heads 301 and the exhausters 302 move forwards and backwards in circles on the same shaft line in the cylinder jackets 21 of the cylinders 2. At the same time, the piston heads 301 and the exhausters 302 are moved by the four piston links 42 to generate mechanical energy. Via the first fluid channel 12 and the second fluid channel 13, the fluid moves in circles between the first fluid channel 12 and the second fluid channel 13 and the power pistons 3 maintain a recycling action.

The first fluid channel 12 is a heating channel, and the second fluid channel 13 is a cooling channel. The fluid executes a recycling heat-exchanging process via the first fluid channel 12 and the second fluid channel 13. The power piston 3 is made of aluminum, and the surface of the power piston 3 is covered with a wear resistant material in an anode-processing method that increases the functions of the wear resistant and heat resistant when the power piston is moving in the cylinder 2. The wear resistant material is an aluminum diamond like carbon (ADLC).

The thermal storing device 303 received in the exhauster 302 is composed of a porous and ventilative material. The thermal storing device 303 rapidly absorbs and stores the thermal energy produced by the heater 22 to drive the power piston 3. Therefore, the preheating process is enhanced and the operating efficiency of the power piston 3 increases.

The present invention further includes a transmitting mechanism (not shown in the figure) linked to the link mechanism 4. The transmitting mechanism transmits the mechanical energy produced by the link mechanism 4 to drive a generator (not shown in the figure) to generate electrical power. The transmitting mechanism can be composed of gears, bevel cams, cam rotors, or springs. The transmitting mechanism cooperates with the generator to convert the mechanical energy produced by the link mechanism into electrical energy.

The present invention utilizes the principle of expanding when hot and shrinking when cold of the Stirling engine to convert the thermal energy of a fluid into a mechanical energy via the link mechanism 4. Sequentially, the transmitting mechanism linked to a generator makes the generator move so that the mechanical energy is converted into electrical energy via the generator. Therefore, the present invention can produce electrical energy by utilizing the heater 22 and the Stirling principle.

The cylinder cover 20 has a cylinder channel 23 to make the fluid flow between the first fluid channel 12 and the second fluid channel 13 in a circular manner. The present invention also installs the airflow channel 31 in the power piston 3 to reduce the weight of the power piston 3 and balance the pressure between an air operating area (the operating range for the piston base 1, the cylinder 2, and the power piston 3) and a mechanical transmitting area (the operating range for the link mechanism 4, the transmitting mechanism, and the generator).

Furthermore, the present invention installs an airflow channel 31 in the power piston 3 to achieve the pressurizing effect and the decompressing effect. By adjusting the pressure in the piston, the operating efficiency of the power piston 3 and the cylinder 2 is improved and increased.

The present invention further includes a temperature sensor 24 linked to the heater 22 for detecting the temperature of the heater 22, and a temperature controller 25 linked to the temperature sensor 24. The temperature controller 25 controls the temperature of the heater 22 via the feedback from the temperature sensor 24. Therefore, by sensing the temperature of the fluid via the temperature sensor 24 and the temperature controller 25 to determine whether the temperature of the fluid is too high or not, the heater 22 is controlled. Deformation between the power piston 3 and the cylinder 2 caused by overheating is avoided. The temperature sensor 24 can be a thermocouple.

The present invention installs an airflow channel 31 and the exhauster 302 in the power piston 3 and utilizes the fluid flowing between the first fluid channel 12 and the second fluid channel 13. The present invention has the following characteristics:

1. By adjusting the pressure via the airflow channel 31, the power piston will not shrink due to expanding excessively.

2. By utilizing the characteristic of thermal storage of the exhauster 302, the heating process is speeded up so as to reduce power consumption.

3. By installing the airflow channel 31 in the power piston 3, the weight of the power piston 3 is reduced and the pressure between an air operating area and a mechanical transmitting area is balanced.

4. By installing an airflow channel 31 in the power piston, a pressurizing effect and a decompressing effect are achieved. By adjusting the pressure in the piston, the operating efficiency of the power piston 3 and the cylinder 2 is improved and increased.

The description above only illustrates specific embodiments and examples of the invention. The invention should therefore cover various modifications and variations made to the herein-described structure and operations of the invention, provided they fall within the scope of the invention as defined in the following appended claims.

What is claimed is:

1. A power structure for a power-saving engine, comprising:
a piston base having a base body, four piston areas are formed at the base body, and a first fluid channel and a second fluid channel are respectively formed at the base body;
four cylinders respectively installed at the four piston areas of the base body, wherein each of the cylinders has a cylinder cover, a cylinder jacket located in the cylinder cover, and a heater located at the bottom of the cylinder cover;
four power pistons respectively corresponding to the cylinders and moving between the cylinders and the moving areas, wherein the power piston has a piston body, an airflow channel is formed in and passes through the piston body, and the piston body has a piston head, and an exhauster located at the piston head; and
a link mechanism having a fastening column fastened at the piston base, a link base is rotatably linked to the fastening column, and four piston links are respectively linked to the link base;
thereby, the power pistons and the exhausters are moved forwards and backwards in circles on a same shaft line in the cylinders via the piston link to generate mechanical energy, and via the first fluid channel and the second fluid channel, the pistons maintain a recycling action.

2. The power structure for a power-saving engine as claimed in claim 1, wherein the first fluid channel is a heating channel, and the second fluid channel is a cooling channel.

3. The power structure for a power-saving engine as claimed in claim 1, wherein the heater is a stove, or a row of fires.

4. The power structure for a power-saving engine as claimed in claim 1, wherein the piston is made of aluminum.

5. The power structure for a power-saving engine as claimed in claim 1, wherein the surface of the power piston is covered with a wear resistant material, and the wear resistant material is an aluminum diamond like carbon.

6. The power structure for a power-saving engine as claimed in claim 1, wherein the exhauster is a thermal storing device.

7. The power structure for a power-saving engine as claimed in claim 6, wherein the thermal storing device is composed of a porous and ventilative material.

8. The power structure for a power-saving engine as claimed in claim 1, wherein the cylinder cover has a cylinder channel that makes a fluid flow between the first fluid channel and the second fluid channel in a circular manner.

9. The power structure for a power-saving engine as claimed in claim 8, further comprising a temperature sensor linked to the heater for sensing the temperature of the heater.

10. The power structure for a power-saving engine as claimed in claim 9, further comprising a temperature controller linked to the temperature sensor, wherein the temperature controller controls the temperature of the heater via the feedback from the temperature sensor.

11. The power structure for a power-saving engine as claimed in claim 9, wherein the temperature sensor is a thermocouple.
